(19) United States
(12) Patent Application Publication
(10) Pub. No.: US 2014/0151181 A1
(43) Pub. Date: Jun. 5, 2014

(54) CLUTCH ASSEMBLY

(71) Applicant: Schaeffler Technologies AG & Co. KG, Herzogenaurach (DE)

(72) Inventor: Dirk Reimnitz, Buehl (DE)

(73) Assignee: Schaeffler Technologies AG & Co. KG, Herzogenaurach (DE)

(21) Appl. No.: 14/172,129

(22) Filed: Feb. 4, 2014

Related U.S. Application Data
(63) Continuation of application No. PCT/DE2012/000694, filed on Jul. 12, 2012.

(30) Foreign Application Priority Data
Aug. 5, 2011 (DE) 102011080484.6

(51) Int. Cl. F16F 15/31

(52) U.S. Cl. CPC F16F 15/31
USPC 192/30 V

(57) ABSTRACT

A clutch assembly for coupling a drive shaft of a motor vehicle engine with at least one transmission input shaft of a motor vehicle transmission is provided, having a dual mass flywheel which can be connected to the drive shaft to damp torsional vibrations, where the dual mass flywheel has a primary mass to introduce a torque and a secondary mass to extract a torque, the primary mass being coupled with the secondary mass by means of a bow spring situated in a bow spring channel so that it can be rotated to a limited extent, a clutch that can be connected to at least one transmission input shaft, and a final assembly means to connect the drive shaft to the at least one transmission input shaft via the clutch assembly, where the final assembly means is connected to the primary mass directly or via a starter gear rim.

### CROSS-REFERENCE TO RELATED APPLICATIONS

This application is filed under 35 U.S.C. §120 and §365(c) as a continuation of International Patent Application No. PCT/DE2012/000694, filed Jul. 12, 2012, which application claims priority from German Patent Application No. 10 2011 080 484.6, filed Aug. 5, 2011, which applications are incorporated herein by reference in their entireties.

### FIELD OF THE INVENTION

The invention relates to a clutch assembly, and in particular, to a drive shaft of a motor vehicle engine coupled with at least one transmission input shaft of a motor vehicle transmission.

### BACKGROUND OF THE INVENTION

A clutch assembly is known, for example from German Patent Application No. 10 2008 004 150 A1, where a dual mass flywheel is connected via a spline connection to a clutch designed as a dual clutch, to damp torsional vibrations of a crankshaft of a motor vehicle combustion engine. During assembly, the dual mass flywheel is first connected to the crankshaft, while the dual clutch is connected to the transmission input shafts of the motor vehicle transmission. The crankshaft is then coupled with the transmission input shaft by plugging the spline connection of the dual mass flywheel which is connected to the crankshaft into the spline connection of the clutch which is connected to the transmission input shafts. In order to compensate for an offset in the circumferential direction and prevent clattering, the parts of the spline connection which are plugged into each other can be braced tangentially by means of a tensioning unit.

There is a constant need to be able to adapt the construction space requirements of clutch assemblies to different construction forms of motor vehicle transmissions and motor vehicle engines without making assembly more difficult.

### BRIEF SUMMARY OF THE INVENTION

The object of the invention is to create a clutch assembly which makes it possible to easily assemble a motor vehicle engine with a motor vehicle transmission with a small construction space requirement.

In one embodiment, a clutch assembly for coupling a drive shaft of a motor vehicle engine with at least one transmission input shaft of a motor vehicle transmission is provided, having a dual mass flywheel which can be connected to the drive shaft to damp torsional vibrations, where the dual mass flywheel has a primary mass to introduce a torque and a secondary mass to extract a torque, the primary mass being coupled with the secondary mass by means of a bow spring situated in a bow spring channel so that it can be rotated to a limited extent, a clutch, for example, a dual clutch, that can be connected to at least one transmission input shaft, and a final assembly means to connect the drive shaft to the at least one transmission input shaft via the clutch assembly, where the final assembly means is connected to the primary mass directly or via a starter gear rim, and the bow spring channel is centered radially on the primary mass. By omitting the spline connection between the dual mass flywheel and the clutch, the construction space required radially within the dual mass flywheel can be reduced, thus enabling a simple assembly of the motor vehicle engine with the motor vehicle transmission with little construction space required.

The basic inventive concept is based on canceling the pre-assembly of the dual mass flywheel with the drive shaft (engine-side sub-assembly) and the pre-assembly of the clutch with the transmission input shaft (transmission-side sub-assembly) and connecting the dual mass flywheel solidly to the clutch without a spline connection. To this end, the point of separation between the engine-side sub-assembly and the transmission-side sub-assembly is shifted, in particular into the dual mass flywheel or into the clutch, in such a way that the final assembly means, for example, a screw, can join the sub-assemblies together for the final assembly of the engine unit with the transmission unit at a location which is easily accessible from outside. The final assembly means is, for example, mounted so that it cannot be lost, and/or is secured against loosening or falling out by means of a screw retainer (such as a self-impeding or externally-impeding screw retainer or loss prevention device, for example a washer with locking teeth). For example, the dual mass flywheel is connected to the clutch via a firm connection, for example, a riveted connection or threaded connection, so that a spline connection between the dual mass flywheel and the clutch is not required, thus reducing the risk of clattering sounds. This is possible, for example, during final assembly, when the clutch assembly is connected to the transmission input shaft, where a radial and/or axial tolerance equalization can be achieved.

Because the final assembly means joins the primary mass, which includes the bow spring channel, with a connecting plate (flex plate or drive plate) or a flywheel which is attached to the crankshaft, the primary mass and secondary mass of the dual mass flywheel together with the clutch can be assigned to the transmission-side sub-assembly. To this end, the final assembly means is designed, for example, as a screw, which is screwed into a Hind hole with female threading, which is formed in the primary mass. This enables a simple final assembly, by means of a screwed connection in an axial or radial direction. At the same time, this arrangement of the means of final assembly makes a simple geometry possible for the primary mass, which may be configured, for example, with an essentially L-shaped cross section. That makes it possible to center the bow spring channel radially on the flywheel/connecting plate/flexplate/drive plate, without the need of a cover connected to the flywheel/connecting plate/flexplate/drive plate, preferably by welding, for the radial centering. For example, the flywheel/connecting plate/flexplate/drive plate has a contour facing radially inward, having a partially circular cross section. That enables the bow spring channel to be inserted into a corresponding contouring of the primary mass, so that at the same time simple assembly of the dual mass flywheel results.

To tie in an electric starter, a starter gear rim may also be connected to the primary mass, for example, by welding, where in this case the primary mass may be connected to the final assembly means indirectly, via the starter gear rim. For example, the starter gear rim may form female threading for the final assembly means in the form of a screw, where to this end the starter gear rim has, for example, a through hole provided with the female threading, which can be produced quickly and easily. It is also possible for the starter gear rim to be connected to the flywheel by welding, for example, and for the final assembly means to be passed through a through hole formed in the starter gear rim or the flywheel.

Because of the final assembly means, the final connection of the drive shaft of the motor vehicle engine is accomplished using the at least one transmission input shaft of the motor vehicle transmission. In the previous assembly steps, either components in the motor-side sub-assembly were connected directly or indirectly to the drive shaft, or components in the transmission-side sub-assembly were connected directly or indirectly to the at least one transmission input shaft. The engine-side sub-assembly is connected to the transmission-side sub-assembly by means of the final assembly means, while in so doing there is also, for example, an alignment of the drive shaft with the transmission input shaft. When there are fluctuations in the speed of rotation of the drive shaft, which may be caused by fuel consumption of the motor vehicle engine, energy can be stored and released again because of the bow spring, so that fluctuations in speed of rotation can be damped or canceled with a high degree of efficiency due to the limited rotatability of the secondary mass relative to the primary mass. The essentially circumferentially oriented bow spring, for example, two or more bow springs positioned radially within one another, can be guided radially outward by the bow spring channel, where the bow spring channel may be greased with a lubricant, for example, with a lubricating grease.

For example, a sheet metal spring, especially a flexplate, is connected to the primary mass by means of the final assembly means, while the primary mass rests through an axial stop against a component which is connected to the sheet metal spring, for example, a flywheel which can be connected to the drive shaft, and the sheet metal spring is prestressed in the axial direction to stiffen the sheet metal spring. The sheet metal spring usually has a lesser axial thickness than a flywheel, thus, saving construction space in the axial direction.

Alternatively, as a flexplate the sheet metal spring can make an axial equalization possible. If this is not necessary, it is possible to brace the sheet metal spring so that the sheet metal spring behaves essentially like a rigid component. To this end, the sheet metal spring may be braced by means of the final assembly means in such a way that the sheet metal spring for example presses an axial stop of the primary mass against a flywheel.

The invention also relates to a clutch assembly for coupling a drive shaft of a motor vehicle engine having at least one transmission input shaft of a motor vehicle transmission to a dual mass flywheel which can be connected to the drive shaft, to damp torsional vibrations, where the dual mass flywheel has a primary mass to introduce a torque and a secondary mass to extract a torque, having a clutch which can be connected to at least one transmission input shaft, for example, a dual clutch, having a final assembly means to connect the drive shaft to the at least one transmission input shaft via the clutch assembly, and having a driver ring to connect the dual mass flywheel to the clutch, where the clutch has a counter plate to press a clutch plate between the counter plate and a pressure plate with frictional engagement, where the driver ring has a first partial ring which is connected to the secondary mass and a second partial ring which is connected to the clutch, the first partial ring and the second partial ring being connected to each other by the final assembly means.

Let it be noted here that the term “partial ring” as used in the present invention is understood to mean both closed rings and a plurality of individual (ring) segments or similar connecting components as coupling elements. These segments or coupling elements are then positioned accordingly, distributed in the circumferential direction. The driver ring can also be designed as a ring having a plurality of arms that are extended in a radial direction, which are connected to the individual clutch elements/segments/connecting components.

The driver ring is a different component, separate from the counter plate. The second partial ring is connected to the counter plate of the clutch. The counter plate is, for example, a central plate of a dual clutch according to the “three plate design,” which constitutes the counter plate for both a first friction clutch and a second friction clutch. For a dual clutch according to the “four plate design,” in which a separate counter plate is provided for each friction clutch, the second partial ring can be connected to the counter plate of the friction clutch which is directed away from the dual mass flywheel, while the first partial ring and the second partial ring can simultaneously constitute the counter plate for the friction clutch which is directed toward the dual mass flywheel. By dividing the driver ring, it is possible to provide a division of the engine-side and transmission-side sub-assemblies at a defined location, so that the separation point defined thus can be suitably chosen in order to achieve easy accessibility for the final assembly means. By omitting the spline connection between the dual mass flywheel and the clutch, the construction space required radially within the dual mass flywheel can be reduced, enabling simple assembly of the motor vehicle engine with the motor vehicle transmission with little construction space needed. For example, it is possible to connect the engine-side sub-assembly to the transmission-side sub-assembly radially outside of the bow spring of the dual mass flywheel or at the radial level of the bow spring, by means of the final assembly means. This makes good accessibility possible in an axial or radial direction. The first partial ring is connected to the secondary mass, for example, by means of a riveted connected or a threaded connection. An axial stretch between the dual mass flywheel and the clutch is bridged over by the driver ring.

The final assembly means, for example, is essentially radially oriented. This enables the final assembly means to be inserted in a radial direction past the components of the dual mass flywheel and the clutch. For example, the final assembly means is secured against unintended loosening by a loss prevention device. The final assembly means can be designed as a screw, which can be screwed into the female threading of the first partial ring and/or of the second partial ring. To form the female threading, the first partial ring and/or the second partial ring can have a thickening. Furthermore, the final assembly means can be screwed into a nut which is attached to the first partial ring or the second partial ring, for example, by welding.

The second partial ring is, for example, connected to a clutch cover of the clutch to cover a part of the clutch, or to a counter plate of the clutch to press a clutch plate between the counter plate and a pressure plate with frictional engagement. The clutch cover and the counter plate can be connected to each other non-rotatingly, so that it is sufficient to connect the second partial ring either to the counter plate or to the clutch cover.

The invention also relates to a clutch assembly for coupling a drive shaft of a motor vehicle engine having at least one transmission input shaft of a motor vehicle transmission to a dual mass flywheel which can be connected to the drive shaft, to damp torsional vibrations, where the dual mass flywheel has a primary mass to introduce a torque and a secondary mass to extract a torque, having a clutch which can be connected to at least one transmission input shaft, for example, a dual clutch, having a final assembly means to connect the drive shaft to the at least one transmission input shaft via the clutch assembly, and having a driver ring to connect the dual mass flywheel to the clutch, where the clutch has a counter plate to press a clutch plate between the counter plate and a pressure plate with frictional engagement and the driver ring is a different component than the counter plate, where the driver ring is connected to the counter plate or a clutch cover of the clutch via the final assembly means to cover a part of the clutch, the final assembly means being oriented essentially in a radial direction or essentially in an axial direction.

Because of the connection of the driver ring with the counter plate or the clutch cover, it is especially simple to find a readily accessible position for the final assembly means, without it being necessary to provide a spline connection between the dual mass flywheel and the clutch. By omitting the spline connection between the dual mass flywheel and the clutch, the construction space required radially within the dual mass flywheel can be reduced, enabling the simple assembly of the motor vehicle engine with the motor vehicle transmission with little construction space needed. For example, it is possible to connect the engine-side sub-assembly to the transmission-side sub-assembly radially outside of the bow spring of the dual mass flywheel or at the radial level of the bow spring, by means of the final assembly means. This enables good accessibility in an axial or radial direction.

For example, the primary mass provides an essentially axially-running through opening for assembly which the final assembly means can pass through. This makes it possible to insert the final assembly means through the freed cutout of the assembly opening into the interior of the clutch assembly, in order to connect the engine-side sub-assembly to the transmission-side sub-assembly. To this end, the primary mass may provide, for example, a through opening, or a cutout which is open radially toward the outside.

The final assembly means, for example, has a centering cone to align the components which are to be connected. This enables the engine-side sub-assembly and the transmission-side sub-assembly to be aligned automatically during the assembly of the final assembly means. The final assembly means may be designed, for example, as a screw, whose screw shaft is connected with the screw head via the centering cone. When the screw shaft of the final assembly means is inserted through an opening in the component to be attached and screwed into the other component to be attached, the centering cone can slide along the edge of the opening and thus automatically align the component with the opening. By omitting the spline connection between the dual mass flywheel and the clutch, the construction space required radially within the dual mass flywheel can be reduced, enabling the simple assembly of the motor vehicle engine with the motor vehicle transmission, with little construction space needed.

The invention also relates to a clutch assembly for coupling a drive shaft of a motor vehicle engine with at least one transmission input shaft of a motor vehicle transmission, having a dual mass flywheel which can be connected to the drive shaft to damp torsional vibrations, where the dual mass flywheel has a primary mass to introduce a torque and a secondary mass to extract a torque, a clutch, for example, a dual clutch, that can be connected to at least one transmission input shaft, and a final assembly means to connect the drive shaft to the at least one transmission input shaft via the clutch assembly, where the final assembly means has a centering cone to align the components which are to be connected.

The final assembly means may be designed, for example, as a screw, whose screw shaft is connected with the screw head via the centering cone. When the screw shaft of the final assembly means is inserted through an opening in the component to be attached and screwed into the other component to be attached, the centering cone can slide along the edge of the opening, thus automatically aligning the component with the opening. By omitting the spline connection between the dual mass flywheel and the clutch, the construction space required radially within the dual mass flywheel can be reduced, enabling the simple assembly of the motor vehicle engine with the motor vehicle transmission, with little construction space needed.

The final assembly means is essentially radially oriented. This enables the final assembly means to be inserted in a radial direction past the components of the dual mass flywheel and the clutch. For example, the final assembly means is secured against unintended loosening by means of a loss prevention device.

In one embodiment, the primary mass has a first leg extending essentially radially and a second leg extending essentially axially. This enables the primary mass to be essentially L-shaped in design, resulting in a simple and easily producible geometry for the primary mass. The mass moment of inertia of the primary mass can be simply adjusted by means of the thickness of the legs.

For example, a cover connected to the primary mass, for example, by welding, is provided for covering the bow spring, a sealing device being provided between the primary mass and the cover to seal the secondary mass against the primary mass and the cover. This makes it possible to provide a sufficiently tightly sealed space between the primary mass and the cover to position a greased bow spring. With an essentially L-shaped primary mass, the cover can be positioned essentially opposite the leg of the primary mass which extends in a radial direction, and it can be connected to the leg which extends essentially axially. The primary mass and the cover can thus form an essentially U-shaped channel, whose opening can be closed by the sealing unit. The secondary mass can protrude from the channel formed by the primary mass and the cover, essentially comparable to a flange. The mass moment of inertia of the secondary mass can be simply adapted by means of the thickness of the secondary mass.

In one embodiment, the dual mass flywheel is connected to a flywheel which can be connected to the drive shaft. The mass moment of inertia can be increased by means of the flywheel, so that it is possible to reduce the mass moment of inertia of the primary mass of the dual mass flywheel.

In another embodiment, the clutch is designed as a dual clutch having a first friction clutch and a second friction clutch, where the clutch has a central plate, and the central plate constitutes a counter plate for both the first friction clutch and the second friction clutch to press a clutch plate between the central plate and a pressure plate assigned to the respective friction clutch with frictional engagement. This provides a construction-space-saving dual clutch according to the “three-plate design.” The first friction clutch can have a first pressure plate, which can be moved by means of a first actuating element in order to press a first clutch plate between the first counter plate, formed by the central plate, and the first pressure plate. Accordingly, the second friction clutch can have a second pressure plate, which can be moved by means of a second actuating element in order to press a second clutch plate between the second counter plate, formed by the central plate, and the second pressure plate. The first actuating element and/or the second actuating element is/are configured as a lever, which is formed, for example, by a lever spring which is configured as a diaphragm spring. The respective clutch plate can be connected to the particular transmission input shaft by gearing so that it is rotationally fixed but axially movable. The particular clutch plate can have a friction lining, for example, on each of axial faces which face away from each other, which can come into frictionally engaged contact with a likewise provided friction lining of the associated counter plate and/or pressure plate in order to engage the particular clutch. The particular clutch plate can be connected to the particular output shaft by gearing so that it is rotationally fixed but axially movable.

Alternatively, the assigned counter plate for the particular friction clutch can be formed by a separate component, resulting in a dual clutch according to the “four-plate design”.

The dual clutch, or the dual mass flywheel, can be connected directly or indirectly, for example, to a vibration damper which is positioned upstream on the engine side and/or positioned downstream on the transmission side, for example, a centrifugal force pendulum and/or mass pendulum. Furthermore, the particular clutch plate can be damped by means of a plate damper. The dual clutch or the dual mass flywheel may be connected to the input shaft, for example, via, a rigid plate (drive plate) and/or a bendable and/or flexible plate (flexplate), where the plate is able to transmit torques in order to be able to introduce the torque of the input shaft into the dual clutch. Axially occurring vibrations can be completely or partially damped or canceled by means of the flexible design of the plate.

### BRIEF DESCRIPTION OF THE SEVERAL VIEWS OF THE DRAWINGS

The invention will be explained below by way of example with reference to the accompanying drawings, on the basis of preferred exemplary embodiments; the features depicted below can each depict an aspect of the invention, both individually and in combination. The figures show the following:

FIG. 1 is a schematic sectional view of an installed clutch assembly in a first embodiment;

FIG. 2 is a schematic sectional view of an installed clutch assembly in a second embodiment;

FIG. 3 is a schematic sectional view of an installed clutch assembly in a third embodiment;

FIG. 4 is a schematic sectional view of an installed clutch assembly in a fourth embodiment;

FIG. 5 is a schematic sectional view of an installed clutch assembly in a fifth embodiment;

FIG. 6 is a schematic sectional view of an installed clutch assembly in a sixth embodiment;

FIG. 7 is a schematic sectional view of an installed clutch assembly in a seventh embodiment;

FIG. 8 is a schematic sectional view of an installed clutch assembly in an eighth embodiment;

FIG. 9 is a schematic sectional detailed view of the clutch assembly of FIG. 8;

FIGS. 10A and 10B are examples of a loss prevention device of a screw, as shown in FIG. 2, where FIG. 10A shows the screw during assembly of the clutch and FIG. 10B shows the screw in the tightened state;

FIG. 10C is another example of a loss prevention device for a screw, as shown in FIG. 2;

FIG. 11 is a schematic sectional depiction of a clutch assembly in another embodiment, which is constructed very similarly to the invention as shown in FIG. 4;

FIG. 12 is a schematic sectional depiction of a clutch assembly in another embodiment, which is constructed very similarly to the invention as shown in FIG. 11;

FIG. 13A is a schematic sectional depiction and a schematic spatial depiction of a partial area of a clutch assembly in another embodiment, which is constructed very similarly to the invention as shown in FIGS. 4, 11 and 12, in the region of the connection between the DMF and the clutch, in the initial state;

FIG. 13B is a schematic sectional depiction and a schematic spatial depiction of a partial area of a clutch assembly in another embodiment, which is constructed very similarly to the invention as shown in FIGS. 4, 11 and 12, in the region of the connection between the DMF and the clutch, in the aligned and pre-positioned state;

FIG. 13C is a schematic sectional depiction and a schematic spatial depiction of a partial area of a clutch assembly in another embodiment, which is constructed very similarly to the invention as shown in FIGS. 4, 11 and 12, in the region of the connection between the DMF and the clutch, pressed together in the final position;

FIG. 13D is a schematic sectional depiction and a schematic spatial depiction of a partial area of a clutch assembly in another embodiment, which is constructed very similarly to the invention as shown in FIGS. 4, 11 and 12, in the region of the connection between the DMF and the clutch, with the screws tightened; and,

FIG. 14 is a schematic sectional detailed view of another embodiment of the clutch assembly shown in FIGS. 8 and 9, having a screwed connection with pre-installed screws.

### DETAILED DESCRIPTION OF THE INVENTION

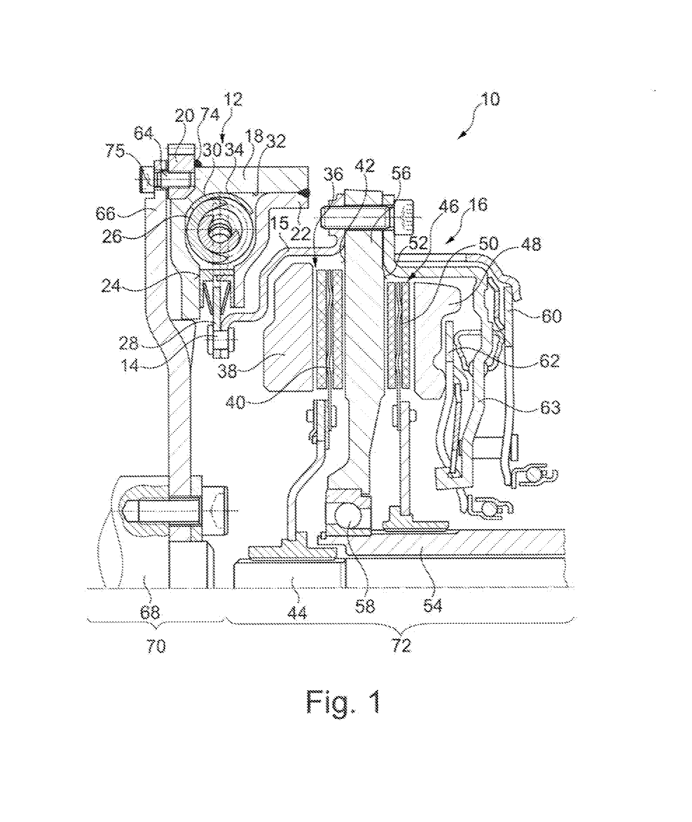

Clutch assembly 10 depicted in FIG. 1 has dual mass flywheel 12 which is fastened to driver ring 15 via fixed fastener 14 in the form of a riveted connection, which driver ring 15 is connected to clutch 16 in the form of a dual clutch, so that a spline connection between dual mass flywheel 12 and clutch 16 is saved. Dual mass flywheel 12 has primary mass 18 with an essentially L-shaped cross section, to which starter gear rim 20 is attached by welding. Attached to primary mass 18 by welding is cover 22, which is sealed off from primary mass 18 at the radially inner end by means of sealing device 24. This seals off a space between primary mass 18 and cover 22, in which greased bow spring 26 can be positioned. Primary mass 18 can introduce a torque into bow spring 26, which can be diverted via secondary mass 28 which likewise acts on bow spring 26. To this end, secondary mass 28 runs through sealing device 24. Bow spring 26 is guided through bow spring channel 30, at least radially on the outside, while lubricating grease prevents unnecessary frictional losses between bow spring channel 30 and bow spring 26. Primary mass 18 has radially inner inside contour 32, which corresponds at least in the angle region of the L-shaped cross section to outside contour 34 of bow spring channel 30, so that bow spring channel 30 can be centered radially on the primary mass.

Clutch 16 has first friction clutch 36 with first pressure plate 38, which is able to press first clutch plate 40 against first counter plate 42, in order to transmit a torque to first transmission input shaft 44 by frictional engagement. In addition, clutch 16 has second friction clutch 46 with second pressure plate 48, which is able to press second clutch plate 50 against second counter plate 52, in order to transmit a torque to second transmission input shaft 54 by frictional engagement. In one embodiment, both first counter plate 42 and second counter plate 52 are formed by common central plate 56, which is braced on second transmission input shaft 54 via thrust bearing 58. Alternatively, first counter plate 42 and second counter plate 52 can be formed by separate components. First pressure plate 38 can be moved by means of first actuating element 60 in the form of a diaphragm spring, while second pressure plate 48 can be moved by means of second actuating element 62 in the firm of a diaphragm spring. A part of clutch 16 can be covered and braced by means of clutch cover 63 which is fastened to central plate 56.

Dual mass flywheel 12 is connected to essentially rigid flywheel 66 by final assembly means 64 in the form of a screw, which is connected to drive shaft 68 configured, for example, as the crankshaft of a motor vehicle combustion engine. Engine-side sub-assembly 70 which is pre-assembled with drive shaft 68 can be connected by final assembly means 64 to transmission-side sub-assembly 72 which is pre-assembled with transmission input shafts 44, 54. In FIG. 1, both clutch 16 and dual mass fly wheel 12 are assigned to transmission-side sub-assembly 72, so that engine-side sub-assembly 70 has only drive shaft 68 and flywheel 66.

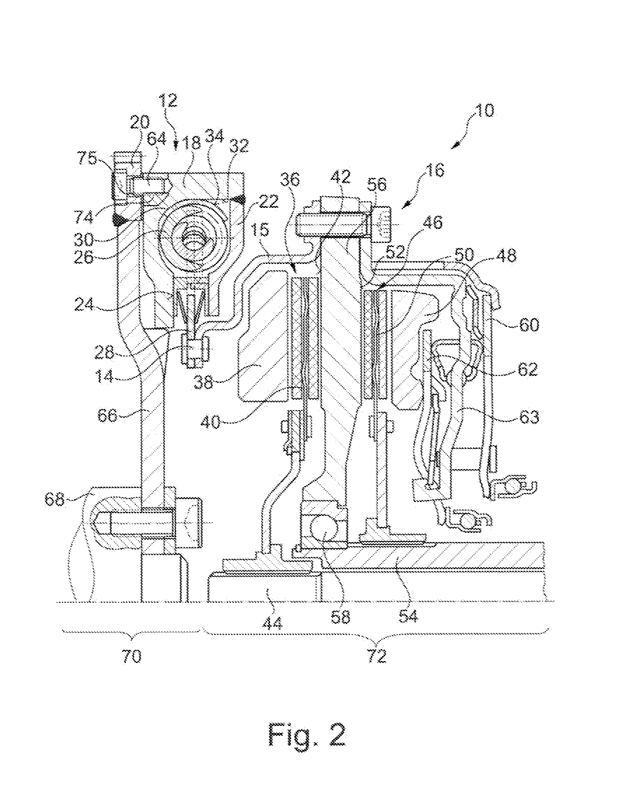

In the embodiment of clutch assembly 10 depicted in FIG. 2, in comparison to the embodiment of clutch assembly 10 depicted in FIG. 1, starter gear rim 20 is not welded to primary mass 18 but to flywheel 66. Female threading 74 for attaching the final assembly means is consequently not provided in starter gear rim 20 but in primary mass 18. Starter gear rim 20 has for this purpose only through hole 75, which is provided in flywheel 66 in the embodiment of clutch assembly 10 depicted in FIG. 1.

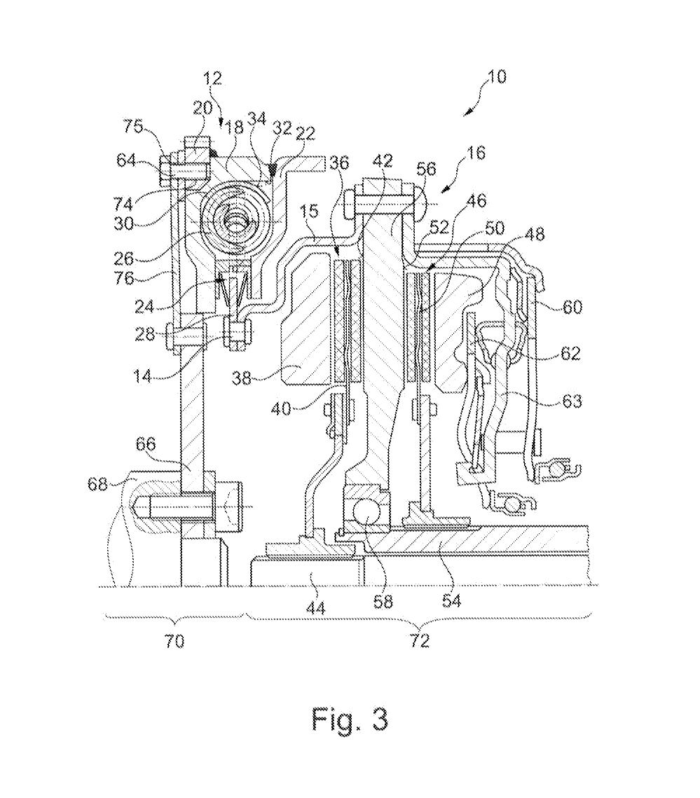

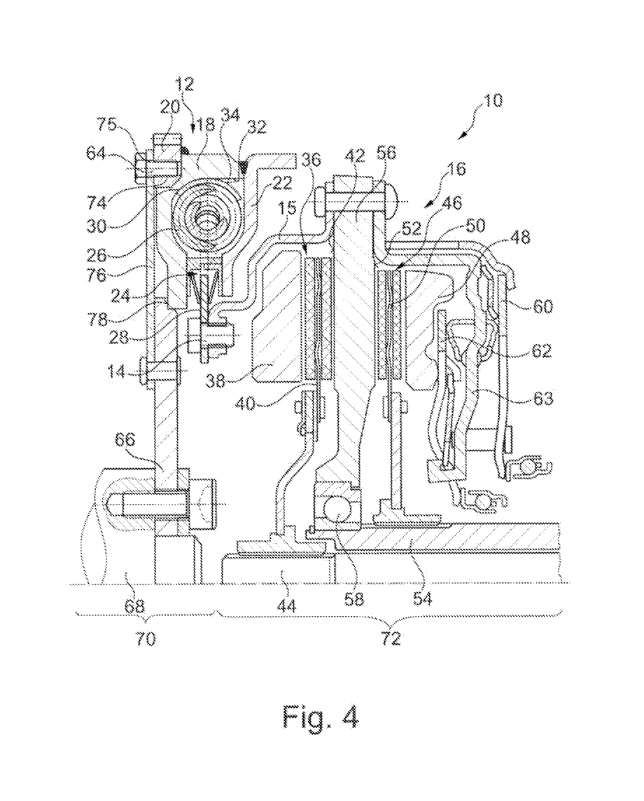

In the embodiment of clutch assembly 10 depicted in FIG. 3, in comparison to the embodiment of clutch assembly 10 depicted in FIG. 1, flywheel 66 is connected to primary mass 18 via sheet metal spring 76 in the form of a flexplate with the aid of final assembly means 64, so that axial vibrations can be damped by means of sheet metal spring 76. As depicted in FIG. 4, sheet metal spring 76 can also be braced in such a way that sheet metal spring 76 acts like a rigid body, so that construction space is saved in the axial direction by sheet metal spring 76, which is thinner in comparison to flywheel 66. To this end, primary mass 18 has axial stop 78, which rests against flywheel 66 with an adequate normal force applied by sheet metal spring 76. Furthermore, in one embodiment, fixed attachment 14 is implemented as a threaded connection.

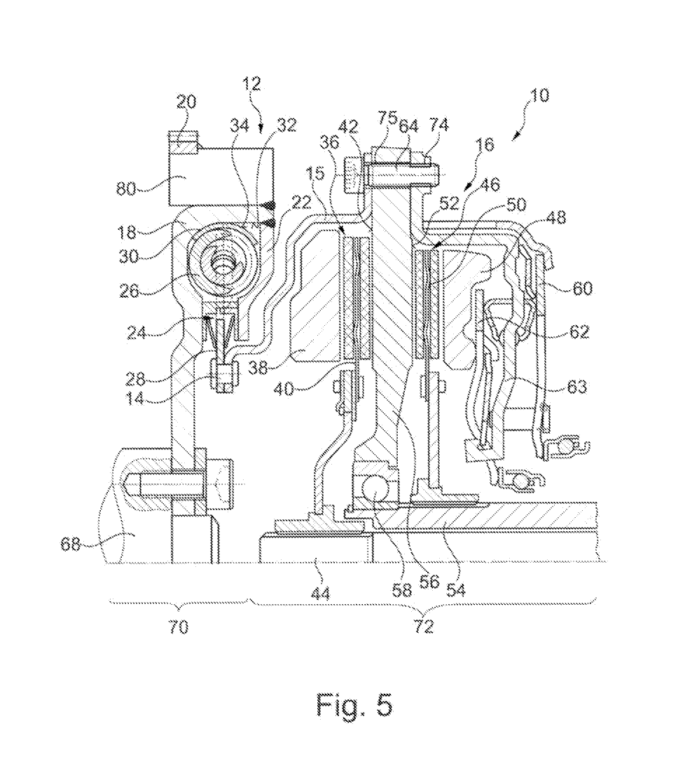

In the embodiment of clutch assembly 10 depicted in FIG. 5, in comparison to the embodiment of clutch assembly 10 depicted in FIG. 1, dual mass flywheel 12 is assigned to engine-side sub-assembly 70. For the connection of engine-side sub-assembly 70 to transmission-side sub-assembly 72, driver ring 15 assigned to engine-side sub-assembly 70 is connected to central plate 56 assigned to transmission-side sub-assembly 72. To this end, final assembly means 64 is in the form of a screw oriented in the axial direction, which is passed through through hole 75 made in the central plate and is screwed into female threading 74 made in clutch cover 63. In order to achieve easy accessibility for final assembly means 64, assembly opening 80 is provided between starter gear rim 20 and primary mass 18, in order to be able to mount final assembly means 64 through assembly opening 80 using a tool. Driver ring 15 may also be connected to central plate 56 by radially oriented final assembly means 64, assembly opening 80 being unnecessary in this case. Furthermore, in one embodiment, primary mass 18 is assembled directly with drive shaft 68. This avoids flywheel 66 as a separate component. In this embodiment, primary mass 18 can at the same time constitute flywheel 66 as a single-piece component.

Furthermore, the connecting means can be aligned “obliquely,” as at an angle between axially and radially.

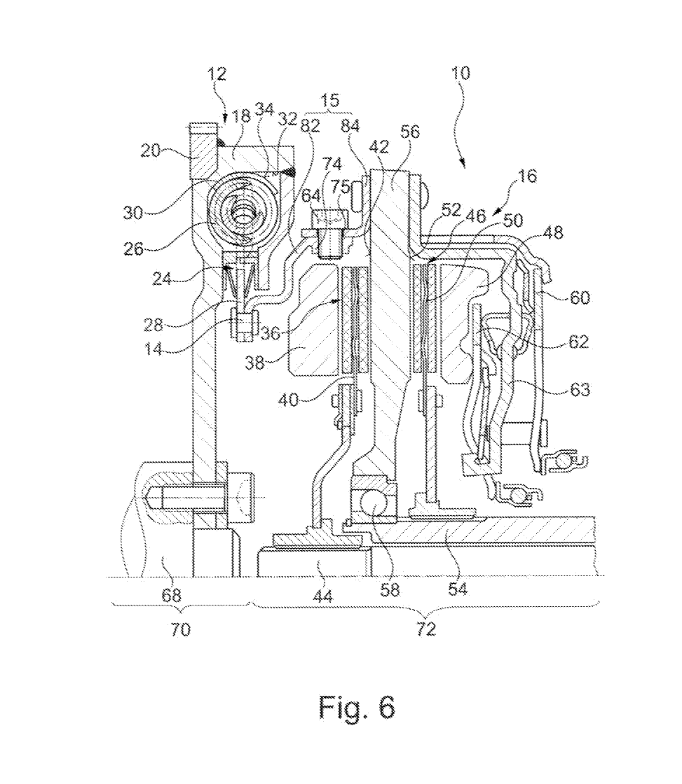

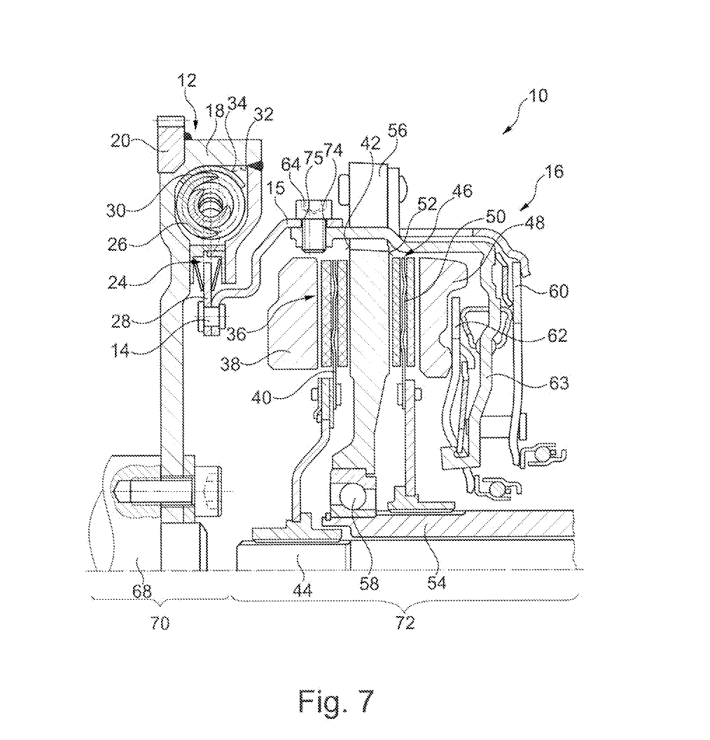

In the embodiment of clutch assembly 10 depicted in FIG. 6, in comparison to the embodiment of clutch assembly 10 depicted in FIG. 5, final assembly means 64 is not oriented axially but radially. In addition, driver ring 15 is subdivided into first partial ring 82, which is fastened to secondary mass 28 via first attachment 14, and second partial ring 84, which is fastened to central plate 56. First partial ring 82 is connected to second partial ring 84 via final assembly means 64. As depicted in FIG. 7, driver ring 15 can also be implemented as a single piece and connected to clutch cover 63 via radially oriented final assembly means 64, comparable to the embodiment depicted in FIG. 6. For example, in the case of the essentially radial orientation of final assembly means 64, final assembly means 64 is secured against unintentional loosening, for example, under the influence of centrifugal force, by means of a loss prevention device.

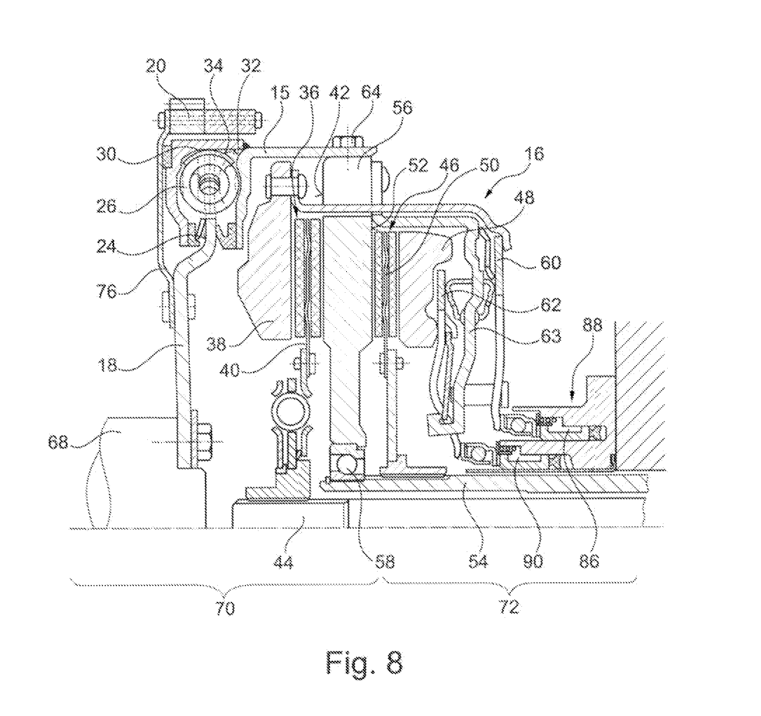

In the embodiment of clutch assembly 10 depicted in FIG. 8, in comparison to the embodiment of clutch assembly 10 depicted in FIG. 3, dual mass flywheel 12 is implemented inversely. That is, primary mass 18 protrudes from radially inside into a space formed by secondary mass 30, 34 from the bow spring channel in one embodiment to FIG. 8 and driver ring 15 connected to this secondary mass 30, 34 by welding, in which bow spring 26 is positioned. Because of the inverse operating mode of dual mass flywheel 12 in this embodiment, driver ring 15 at the same time forms cover 22 for dual mass flywheel 12, so that driver ring 15 and cover 22 are implemented as a single piece. Also in this form of dual mass flywheel 12, driver ring 15 can be connected especially simply with central plate 56 or with clutch cover 63, by radially oriented final assembly means 64. Furthermore, starter gear rim 20 can be connected to primary mass 18 via sheet metal spring 76 in the form of a flexplate.

First actuating means 60 of clutch assemblies 10 depicted above can be operated by hydraulically operable first actuating cylinder 86 of actuating device 88, while second actuating means 62 of clutch assemblies 10 depicted above can be operated by hydraulically operable second actuating cylinder 86 of actuating device 88. First actuating cylinder 86 and second actuating cylinder 90 take the form of a circumferential ring shape, for example, in the circumferential direction, while second actuating cylinder 90 is situated radially within first actuating cylinder 86 or vice versa. As a result, actuating mechanism 88 can be constructed compactly and save construction space accordingly.

The above embodiments of the clutch assemblies were explained in the example of a dual clutch according to the “three plate design.” It is also possible to provide the above systems of the final assembly means in a simple friction clutch or a dual clutch according to the “four plate design.” Furthermore, it is possible, instead of pivotable actuating elements 60, 62, to use directly operable actuating elements, which are not swiveled around a pivot point, and whose actuation path, with the exception of a portion caused by elastic bending, corresponds to the actuation path provided by assigned actuating cylinder 86, 90.

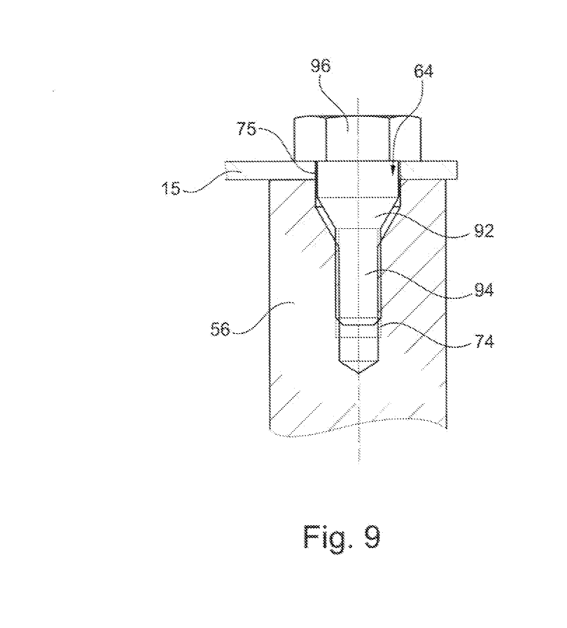

As depicted in FIG. 9, final assembly means 64 can have centering cone 92, in order to align the components which are to be connected, for example, driver ring 15 and central plate 56, with each other automatically during assembly. Final assembly means 64 is, for example, in the form of a screw having screw shaft 94 and screw head 96, while centering cone 92 may be situated between screw shaft 94 and screw head 96. When screwing the screw shaft 94 into female threading 74 of central plate 56, the centering cone can slip off through hole 75 of driver ring 15, and thus align engine-side sub-assembly 17 automatically with central plate 56, and thus with transmission-side sub-assembly 72.

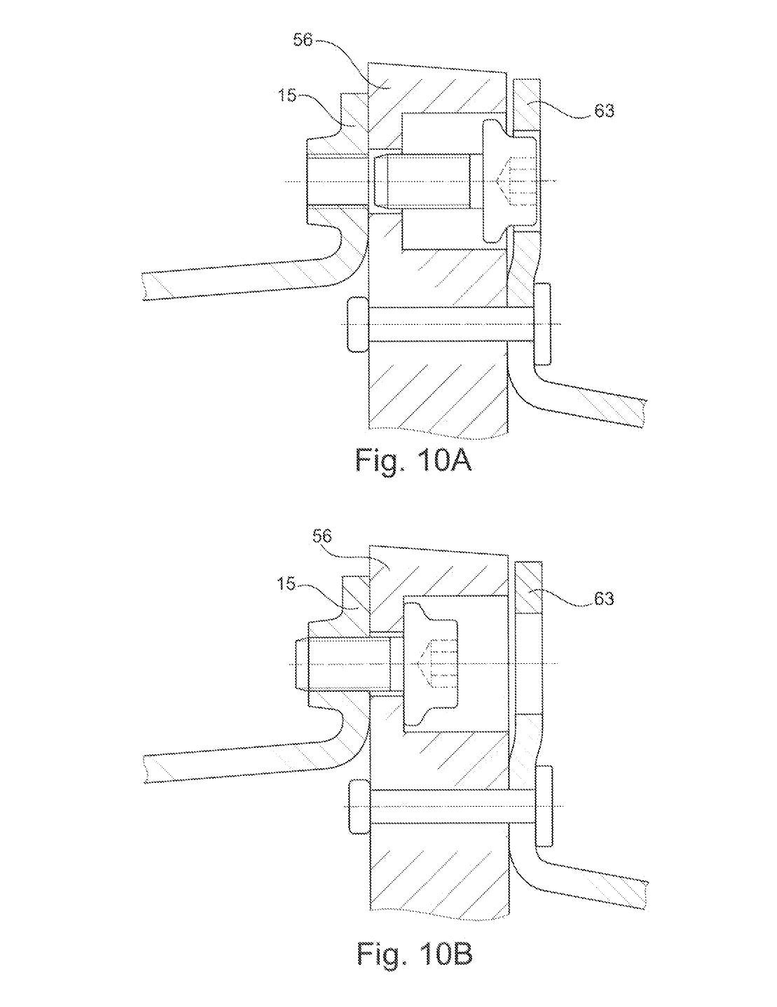

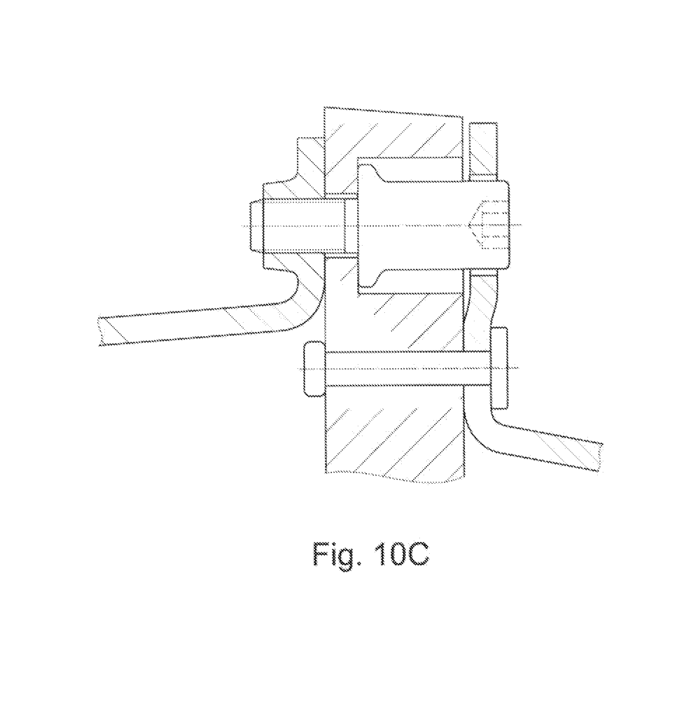

A loss prevention device of the screws (as an example of the final assembly means during assembly will be described next on the basis of FIGS. 10A through 10C, 11, 12 and 13A through 13D. The result that can be achieved using this loss prevention device is that the final assembly means (for example screws) do not have to be introduced into the clutch bell housing separately if they are connected to one of the sub-assemblies already before the engine-side sub-assembly (for example the DMF) and the transmission-side sub-assembly (for example the dual clutch) are fitted together. This reduces the complexity of final assembly, lessens the risk that the elements may fall into the clutch bell housing uncontrolled, and lowers the demands on the assembly openings in the clutch bell housing. Because of the screws, which are already fastened to the component and are pre-positioned thereby, the assembly openings can be smaller, since the openings are needed only for tool access and no large visual range needs to be exposed, as would be necessary, for example, to introduce the final assembly means later. In addition, with pre-positioned screws, the direction of intervention for the tool can deviate more severely from the coaxial direction than in the case of screws introduced subsequently. The pre-positioned screws can be tightened, for example, more easily using tools having a universal joint function, in which the axis of rotation at the tool handle differs from the axis of rotation of the screw.

FIGS. 10A and 10B on the one hand and 10C on the other hand show two examples of how the loss prevention and pre-positioning of the screws can be realized in a simple manner by means of the components which are already present in any case in the dual clutch. What is shown is the separation point between the driver ring and the central plate, at which the screws are secured and pre-positioned by the central plate and the clutch cover. If the screws can be pushed far enough into the sub-assembly to which they are connected by the loss prevention device so that the beginning of the threading can plunge completely under the separation plane, as shown in the illustrations, this protects the screw and the courses of thread on the other sub-assembly while the engine and transmission are being fitted together and aligned.

In order to ensure the basic orientation of the two sub-assemblies, the two sub-assemblies may have special interface geometries that can only be fitted in the correct position and are more robust than the threading locating pins and alignment holes). An additional advantage of the screws, which can be axially relocated in the loss prevention device to a limited extent, is that the two sub-assemblies can first be fitted together as far as their end position, and only then must one begin to screw in and tighten the screws. In the case of screws that lack axial displaceability in the loss prevention device, all of the screws must already begin to be screwed in uniformly, while the sub-assemblies are approaching their final position on the last piece.

FIGS. 10A through 10C are intended to only explain by way of example how a loss prevention device may be implemented. While the moving space for the screw head is formed in the illustrations mainly by the central plate, this role can also be taken over by sheet metal components. The underlying principle can thus be realized at all separation points and separation positions between the engine-side sub-assembly and the transmission-side sub-assembly.

In addition, FIG. 10C shows a screw whose driving geometry at the screw head is always especially accessible. This is advisable for screws that must be tightened from an unfavorable access position. Instead of an elongated head, the accessibility can also be improved by a radially arranged slit in the components that form the moving space for the screw heads. As long as the slit is wider than the tool but narrower than the screw, the screw cannot be lost in spite of the slit.

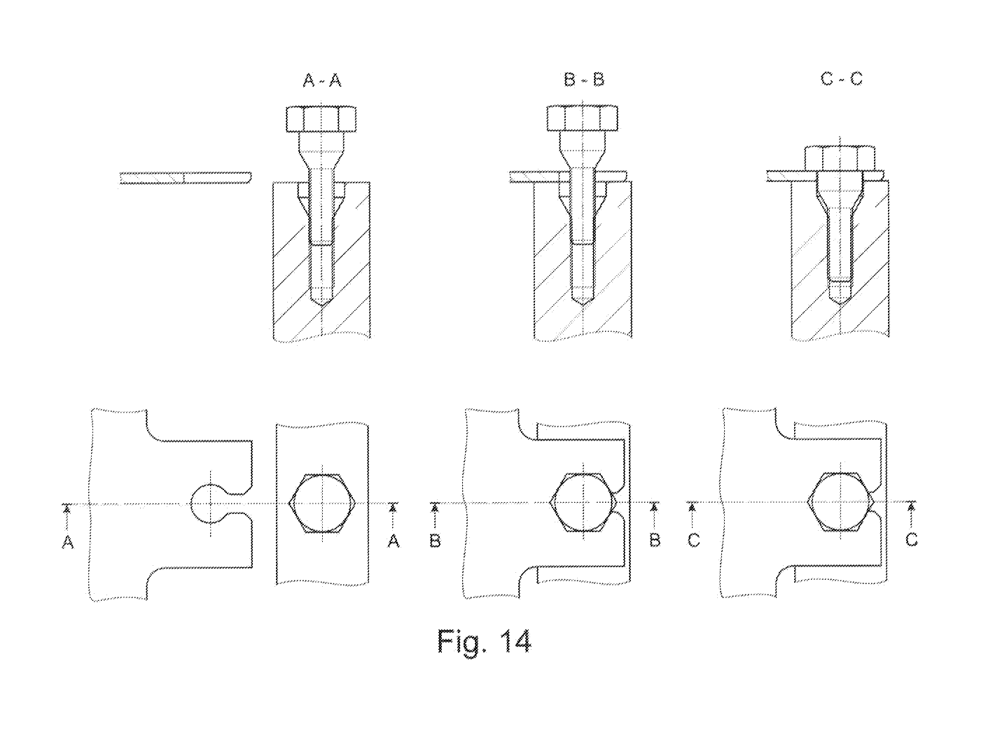

FIG. 14 shows an embodiment with screwed connection having pre-installed screws, implemented for the exemplary embodiment according to FIGS. 8 and 9, which shows a screwed connection with a central cone. FIG. 14A shows the initial state prior to final assembly, FIG. 14B the state in which the sub-assemblies are fitted but not yet screwed together, and FIG. 14C the final state with the sub-assemblies screwed together (if at least one screw has a central cone and is matched to the geometry of the hole, the sub-assemblies are aligned while being screwed together). In a radial screwed connection, if the otherwise usual through holes are not entirely round but are connected to the face of the component via a slit extending axially, these components thus suited can be pushed under the loose screws that are screwed into the neighboring parts which are provided with the threading. Thus, the screws can be screwed into the threading of one of the sub-assemblies even before the engine and transmission are installed, and only still have to be tightened after the pairing with the neighboring sub-assembly. The subsequent introduction of final assembly means into the clutch bell housing can thus be omitted. With the loss prevention device shown in FIG. 14, the connection between the driver ring and central plate can be released, in which case, even in the released state, the screw(s) is/(are) held in the bore of the central plate by means of the bore with smaller diameter in the clutch cover.

The principle shown here on the basis of FIGS. 14A through 14C for radially positioned screwed connections can also be transferred to axially positioned screwed connections. If the slits which lead away laterally from the through holes are arranged tangentially and end in cutouts into which the screw heads can protrude after the two sub-assemblies have been pushed together, the screws can be repositioned from the cutouts through the slits into the through holes by twisting the two sub-assemblies relative to each other. The screws can then be tightened in the through holes, and at the same time, if they are provided with a centering cone, they align the two sub-assemblies which are to be joined.

FIGS. 10A through 10C and 14A through 14C thus show different embodiments with screws that are introduced with loss protection, which do not need to be introduced into the clutch bell housing separately, since they are already connected to one of the clutch components with pre-positioning because of the loss prevention device, which is well suited for screw connecting positions which are difficult to access. Since the screw is already roughly guided and aligned before the threading takes this over, this screw does not have to be screwed in by a coaxially positioned tool. Among other things, this enables tools and assembly openings that are oriented obliquely to the screw position. For this purpose, these illustrations show a loss-protected screw with which the accessibility to the driving geometry on the screw head is not limited by the components holding the screw, either in the loose or in the tightened state.

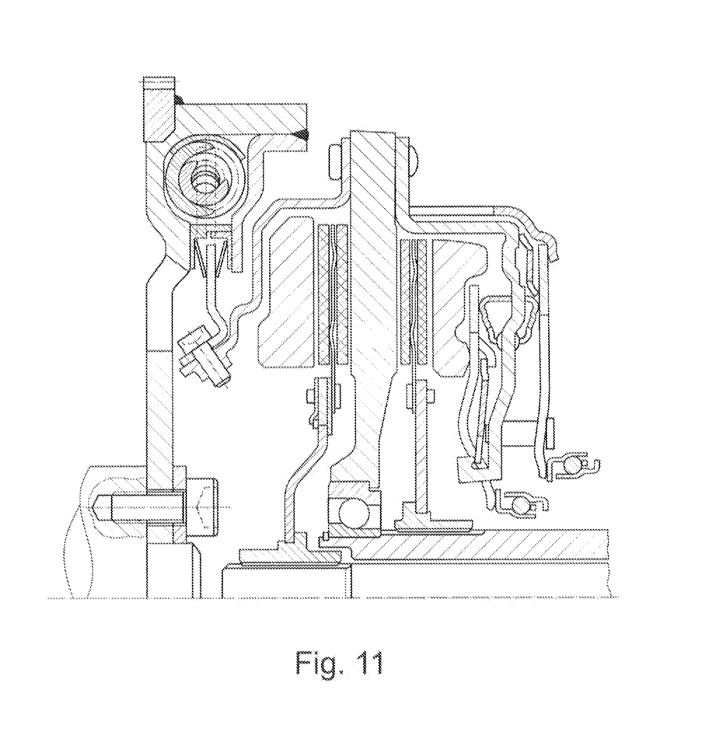

Other than at the locations already described earlier, a threaded connection can also be realized between the DMF flange and the driver ring. In order to enable access to this separation point, which is located relatively deep in the interior of the total assembly, at least one assembly opening in the engine-side region of the clutch bell housing is required. In addition, the DMF primary side must have assembly openings, and the screws should be positioned obliquely to the axis of rotation of the clutch, insofar as possible, so that the screw heads face in the direction of the assembly openings, which are positioned obliquely on the outside. Such an arrangement is shown in FIGS. 11, 12 and 13A through 13D.

For example, FIG. 11 shows the threaded separation point between the DMF flange and the driver ring of the dual clutch, where by means of assembly openings in the DMF primary side and on the engine-side part of the clutch housing, after the engine and transmission have been fitted together the connecting screws can be introduced into the connection point, and the DMF flange and the dual clutch can be screwed together. In this case, the screws are preferably positioned obliquely to the axis of rotation of the clutch, as depicted, so as to be able to tighten the screws from an oblique angle on the outside.

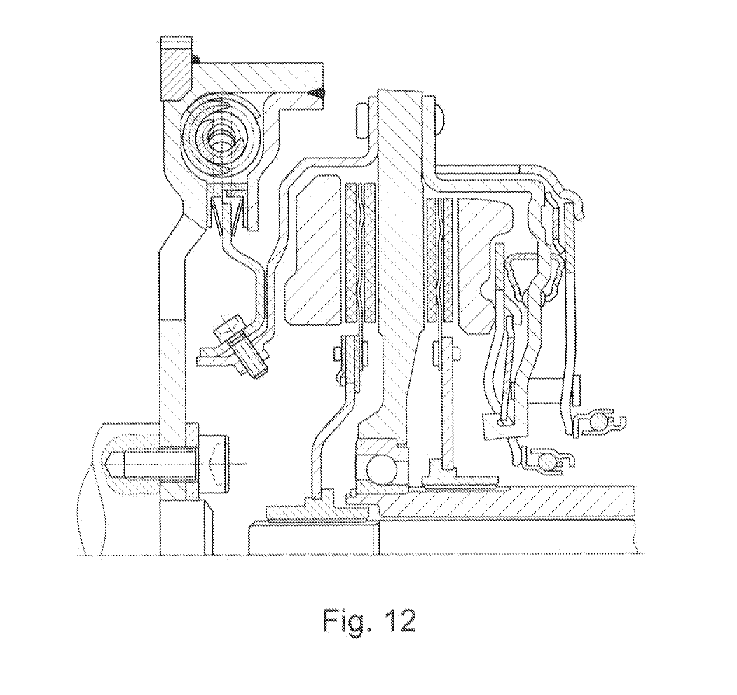

Because of the system, due to the engine contour it will scarcely be possible to tighten all of the screws situated on the circumference at the same time. If the screws are tightened one after the other, care must be taken to ensure that the first screw to be tightened already fixes the components in the correct alignment. For this reason, it makes sense if the neighboring components are not able to rest directly on the conical surface under the screws, but rather the contact surfaces between the DMF flange and the driver ring are situated at an angle to the contact area of the screw head. This causes the components to align themselves automatically when the screw is tightened. (The components are pressed against each other during the tightening until both contact points and the screw head have contact with their neighboring components.) In the clutch depicted in FIG. 12, this is realized by a cylindrical contact surface acting in the radial direction (parallel to the axis of rotation of the clutch) and a flat contact surface acting in the axial direction (orthogonal to the axis of rotation of the clutch).

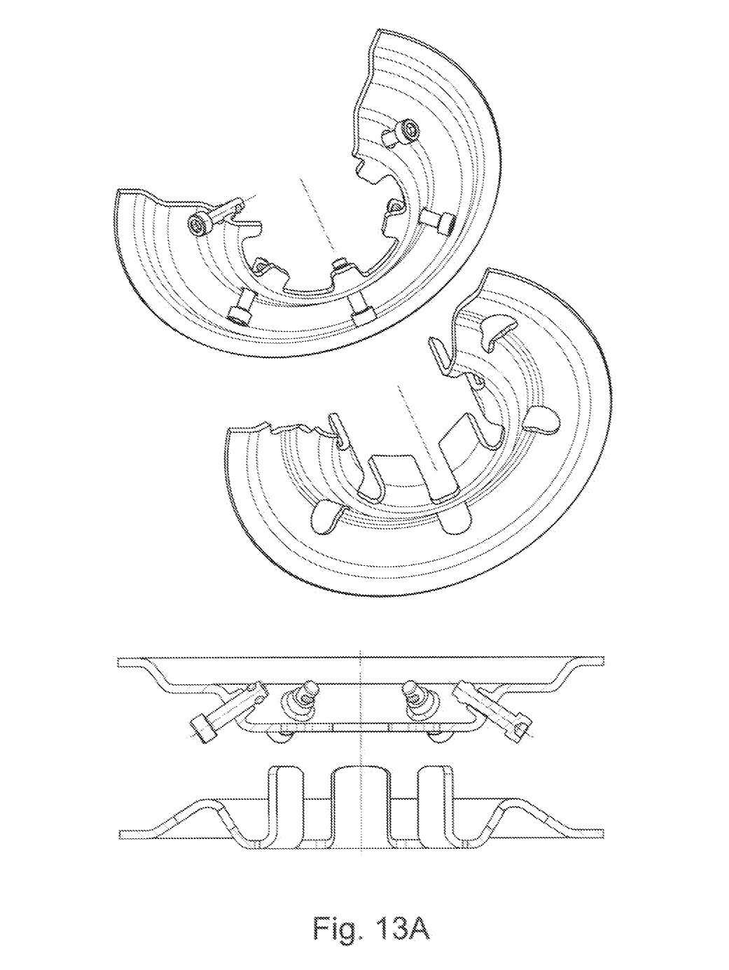

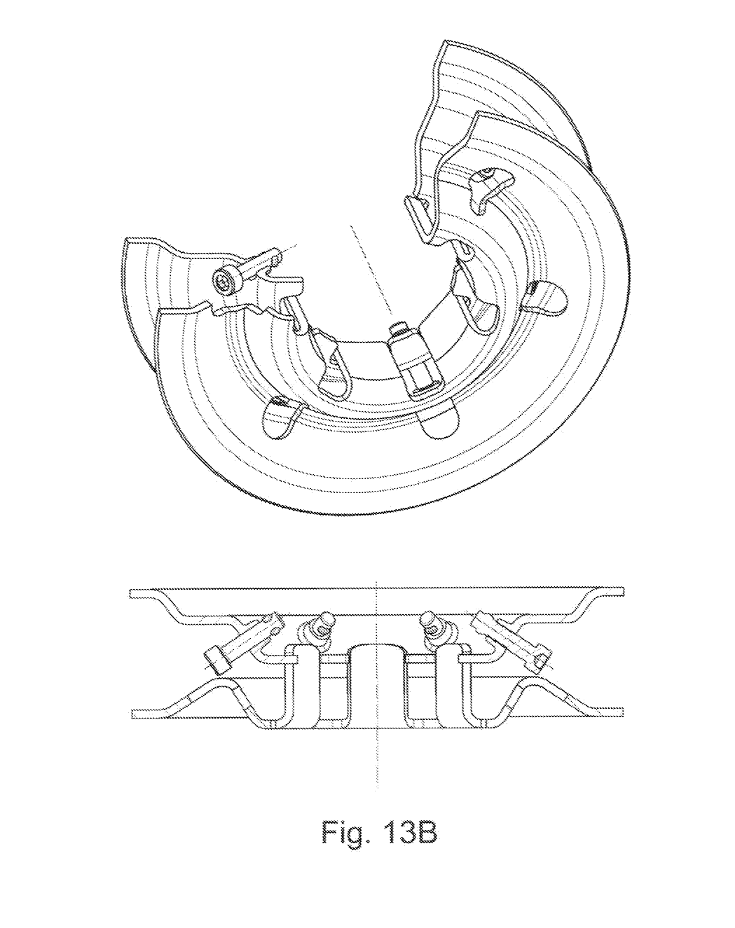

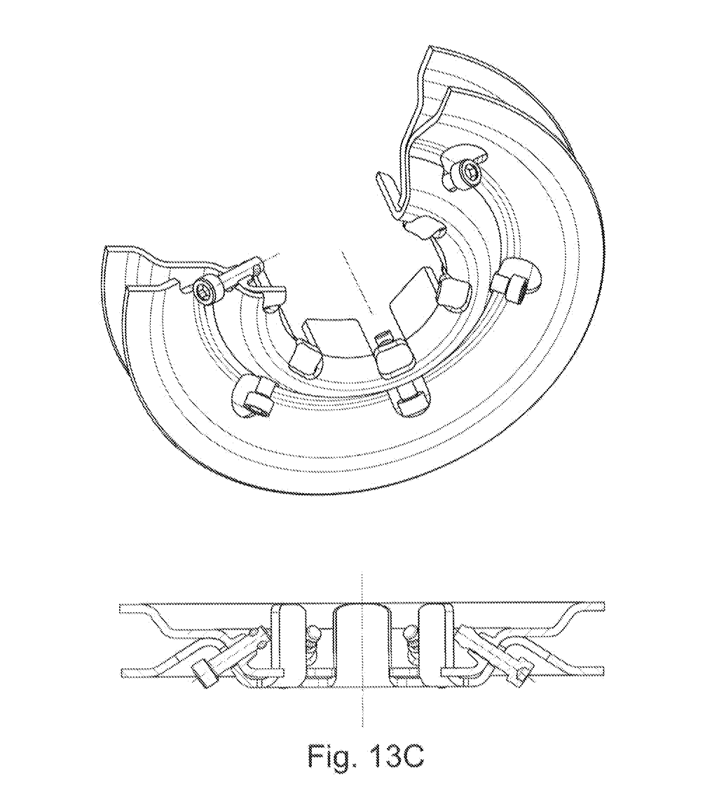

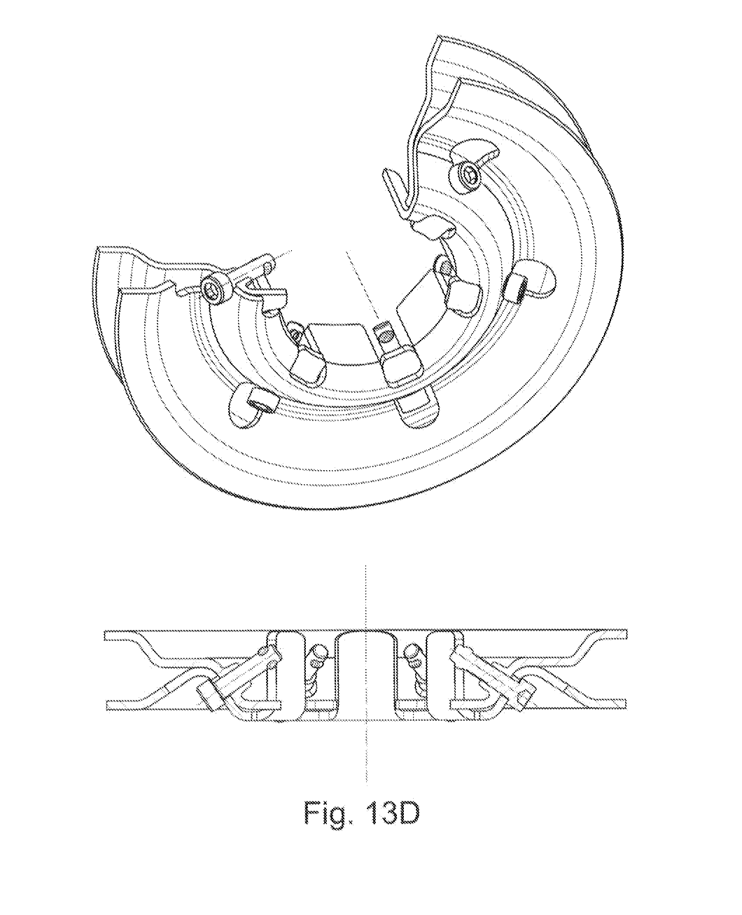

If the contact point acting in the radial direction (this also applies to a tangential centering of FIGS. 13A through 13D) is long enough axially so that it becomes effective at enough locations distributed around the circumference, even with components that are not correctly aligned, to prevent radial migration of the components in all radial directions while the first screw is being tightened, it can take over the complete aligning function together with the conical surface in the area of the screwed connection. The axial stop faces are then no longer required.

Since this screwed connection position is located especially deep in the interior of the clutch assembly, loss-protected screws are especially recommended here. FIGS. 13A through 13D show such a variant and its assembly steps symbolically. The screws are already screwed into the driver ring prior to the final assembly, and in addition they can also be secured against coming completely unscrewed unintentionally (for example, by incorrect embossing of the threading at the end of the screw—depicted in the illustrations—or by additional elements). The initial state prior to assembly of engine and transmission is shown in FIG. 13A. When the two sub-assemblies (DMF and dual clutch) are fitted together during the assembly of the engine and transmission, the screws are pushed through specially shaped openings in the DMF flange (or a component connected to the DMF flange) which enable the screw heads to dip through the flange in the far-unscrewed position and later to meet the flange as the screws are tightened, and thus to enable the transfer of force between the flange and the driver ring. These openings in the DMF flange can have a form resembling a keyhole, for example.

In order to prevent unwanted contact of the screw head with the DMF flange or other components during the fitting together of engine and transmission, in which the screw or the threading can become damaged, exact alignment of the DMF flange and the driver ring is advisable, so that the screws enter the threaded openings directly and without colliding with the flange. The precise alignment can be ensured by an exact assembly sequence with measuring and alignment procedures. Even more secure, however, is the pre-alignment of flange and driver ring by their special geometry, which enables (or ensures) alignment of the two components before the screw heads are pushed through the openings. If the DMF and the dual clutch can only be pushed together in the aligned state, because of this geometry, this protects the screws and prevents the DMF flange and the driver ring from being joined in an incorrect position when the first screw is tightened. As a result, the connecting screws can be tightened one after the other.

### Reference Labels

10 clutch assembly
12 dual mass flywheel
14 fixed attachment
15 driver ring
16 clutch
18 primary mass
20 starter gear rim
22 cover
24 sealing device
26 bow spring
28 secondary mass
30 bow spring channel
32 inside contour
34 outside contour
36 first friction clutch
38 first pressure plate
40 first clutch plate
42 counter plate
44 first transmission input shaft
46 second friction clutch
48 second pressure plate
50 second clutch plate
52 second counter plate
54 second transmission input shaft
56 central plate
58 thrust bearing
60 first actuating element
62 second actuating element
63 clutch cover
64 final assembly means
66 flywheel or flexplate or drive plate
68 drive shaft
70 engine-side sub-assembly
72 transmission-side sub-assembly
74 female threading
75 through hole
76 sheet-metal spring
78 axial stop
80 assembly opening
82 first partial ring
84 second partial ring
86 first actuating cylinder
88 actuating mechanism
90 second actuating cylinder
92 centering cone
94 screw shaft
96 screw head

What is claimed is:

1. A clutch assembly for coupling a drive shaft of a motor vehicle engine with at least one transmission input shaft of a motor vehicle transmission, comprising:
a dual mass flywheel connected to the drive shaft for damping torsional vibrations, wherein the dual mass flywheel has a primary mass to introduce a torque and a secondary mass to extract a torque, the primary mass being coupled with the secondary mass by means of a bow spring situated in a bow spring channel so that it can be rotated to a limited extent;
a clutch connected to at least one transmission input shaft; and,
a final assembly means to connect the drive shaft to the at least one transmission input shaft via the clutch assembly, wherein by means of the final assembly means a flywheel connected to a drive shaft is connected to the primary mass directly or via a starter gear rim and the primary mass is centered radially on the flywheel.

2. The clutch assembly as recited in claim 1, wherein a sheet metal spring is connected to the primary mass by means of the final assembly means while the primary mass rests through an axial stop against a component which is connected to the sheet metal spring, a flywheel which can be connected to the drive shaft, and the sheet metal spring is prestressed in the axial direction to stiffen the sheet metal spring.

3. A clutch assembly for coupling a drive shaft of a motor vehicle engine with at least one transmission input shaft of a motor vehicle transmission, comprising:
a dual mass flywheel connected to the drive shaft for damping torsional vibrations, wherein the dual mass flywheel has a primary mass to introduce a torque and a secondary mass to extract a torque;
a clutch connected to at least one transmission input shaft;
a final assembly means to connect the drive shaft to the at least one transmission input shaft via the clutch assembly; and,
a driver ring to connect the dual mass flywheel to the clutch, where the clutch has a counter plate to press a clutch plate between the counter plate and a pressure plate with frictional engagement, wherein the driver ring has a first partial ring which is connected to the secondary mass and a second partial ring which is connected to the clutch, the first partial ring and the second partial ring being connected to each other by the final assembly means.

4. The clutch assembly as recite(in claim 3, wherein the final assembly means is aligned essentially radially.

5. The clutch assembly as recited in claim 3, wherein the second partial ring is connected to a clutch cover of the clutch to support a part of the clutch, or to a counter plate of the clutch to press a clutch plate between the counter plate and a pressure plate with frictional engagement.

6. A clutch assembly for coupling a drive shaft of a motor vehicle engine with at least one transmission input shaft of a motor vehicle transmission, comprising:
a dual mass flywheel connected to the drive shaft for damping torsional vibrations, wherein the dual mass flywheel has a primary mass to introduce a torque and a secondary mass to extract a torque;
a clutch connected to at least one transmission input shaft;
a final assembly means to connect the drive shaft to the at least one transmission input shaft via the clutch assembly; and,
a driver ring to connect the dual mass flywheel to the clutch, where the clutch has a counter plate to press a clutch plate between the counter plate and a pressure plate with frictional engagement, and the driver ring is a separate component which is different from the counter plate, wherein the driver ring is connected to the counter plate or a clutch cover of the clutch via the final assembly means to cover a part of the clutch, the final assembly means being oriented essentially in a radial direction or essentially in an axial direction.

7. The clutch assembly as recited in claim 6, wherein primary mass provides a through opening extending essentially axially for assembly, to pass through the final assembly means.

8. The clutch assembly as recited in claim 1, wherein the final assembly means has a centering cone to align the components which are to be connected.

9. A clutch assembly for coupling a drive shaft of a motor vehicle engine with at least one transmission input shaft of a motor vehicle transmission, comprising:
a dual mass flywheel connected to the drive shaft for damping torsional vibrations, wherein the dual mass flywheel has a primary mass to introduce a torque and a secondary mass to extract a torque;
a clutch connected to at least one transmission input shaft;
a final assembly means to connect the drive shaft to the at least one transmission input shaft via the clutch assembly, wherein the final assembly means has a centering cone to align the components which are to be connected.

10. The clutch assembly as recited in claim 9, wherein the final assembly means is aligned essentially in the radial direction.

11. The clutch assembly as recited in claim 1, wherein the clutch is in the form of a dual clutch having a first friction clutch and a second friction clutch, wherein the clutch has a central plate and the central plate constitutes a counter plate to press a clutch plate with frictional engagement between the central plate and a pressure plate assigned to the respective friction clutch, both for the first friction clutch and for the second friction clutch.
